(19) United States
(12) Patent Application Publication
(10) Pub. No.: US 2007/0090654 A1
(43) Pub. Date: Apr. 26, 2007

(54) System and method for registering the drive mechanism position of a latch apparatus after power loss

(75) Inventor: William Eaton, Peal City, IL (US)

Correspondence Address: Honeywell International Inc.;Attorney, Intellectual Property, 101 Columbia Rd., P.O. Box 2245, Morristown, NJ, 07962, US

(73) Assignee: Honeywell International Inc.

(21) Appl. No.: 11/255,847

(22) Filed: Oct. 20, 2005

(51) Int. Cl. E05C 3/06

(52) U.S. Cl. 292/201

(57) ABSTRACT

An improved electric latch including latch position registration at power loss. A small motor affects a number of independent electrical actuations using an index gear, actuations of: Central Locking, Super Locking, Selective Locking, Power/electrical door opening (Passive Opening), and Power/electrical door closing (Soft Closing). The improved latch uses at least one sensor and several targets positioned on latch hardware to register drive mechanism positions of a latching system after loss of power. The improved system uses a sensor and target specifically for registered function. The present invention avoids the complexity of prior Latch designs by providing for latch position registration.

### TECHNICAL FIELD

Embodiments are generally related to latch mechanisms. Embodiments are also related to door latch systems utilized in vehicles such as automobiles. Embodiments are additionally related to automatic latch position registration systems. More particularly, the present invention is related to a system and method for registering the drive mechanism position of a latching system after loss of power.

### BACKGROUND OF THE INVENTION

Latching mechanisms (i.e., “latches”) are utilized in a variety of commercial and industrial applications, such as automobiles, airplanes, trucks, and the like. For example, an automotive closure, such as a door for an automobile passenger compartment, is typically hinged to swing between open and closed positions and conventionally includes a door latch that is housed between inner and outer panels of the door. The door latch functions in a well-known manner to latch the door when it is closed and to lock the door in the closed position or to unlock and unlatch the door so that the door can be opened manually.

The door latch can be operated remotely from inside the passenger compartment by two distinct operators—a sill button or electric switch that controls the locking function and a handle that controls the latching function. The door latch is also operated remotely from the exterior of the automobile by a handle or push button that controls the latching function. A second distinct exterior operator, such as a key lock cylinder, may also be provided to control the locking function, particularly in the case of a front vehicle door. Each operator is accessible outside the door structure and extends into the door structure where it is operatively connected to the door latch mechanism by a cable actuator assembly or linkage system located inside the door structure.

Vehicles, such as passenger cars, are therefore commonly equipped with individual door latch assemblies, which secure respective passenger and driver side doors to the vehicle. Each door latch assembly is typically provided with manual release mechanisms for unlatching the door latch from the inside and outside of the vehicle, e.g. respective inner and outer door handles. In addition, many vehicles also include an electrically controlled actuator for remotely locking and unlocking the door latches.

Automotive latches are increasingly performing complex functions with fewer motors. For example, it is desirable to perform a variety of latch functions with only one motor. In such cases, increased accurate motor control systems and methods are required in order to properly electrically actuate the latch and obtain the desired operation.

The present inventor has invented a system and method for registering the drive mechanism position of a latching system after loss of power that uses sensors and targets specifically located on moving hardware in existing latches for registration functions. The present invention avoids electrical-mechanical malfunctions encountered with power loss using prior Latch designs by using the unique registration system described herein.

### BRIEF SUMMARY OF THE INVENTION

The following summary of the invention is provided to facilitate an understanding of some of the innovative features unique to the present invention and is not intended to be a full description. A full appreciation of the various aspects of the invention can be gained by taking the entire specification, claims, drawings, and abstract as a whole.

It is, therefore, one aspect of the present invention to provide for improved latching system adapted for registering the drive mechanism position of a latching system after loss of power.

The present invention avoids the complexity of prior Latch designs by registering a number of independent actuations including at least two of: Central Locking, Super Locking, Selective Locking, Power/electrical door opening (Passive Opening), Power/electrical door closing (Soft Closing) during powered and power-loss states of operation.

It is another aspect of the present invention to provide a system and method for correcting the position of electrical actuators to accommodate changes in the mechanical position of a latch that occur during power loss.

It is a further aspect of the present invention to provide for an improved latch including power loss registration/latch position registration functions, wherein the latch is designed to fit any type of car and to provide one of 12 versions including: (1) Simple central locking, (2) Central locking with super locking, (3) Central selective locking (including electrical child safety), 1, 2 or 3 with power door release, 1, 2 or 3 with power door latching, or 1, 2 or 3 with both power door release and power door latching.

The aforementioned aspects of the invention and other objectives and advantages can now be achieved as described herein.

### BRIEF DESCRIPTION OF THE DRAWINGS

The accompanying figures, in which like reference numerals refer to identical or functionally-similar elements throughout the separate views and which are incorporated in and form a part of the specification, further illustrate the present invention and, together with the detailed description of the invention, serve to explain the principles of the present invention.

FIG. 1 illustrates a perspective view of a vehicle door mounted to a passenger vehicle in which a preferred embodiment of the present invention can be implemented.

FIG. 2 illustrates an example of a latch drive mechanism and its main components operable for position registration in accordance with the present invention.

FIG. 3 illustrates the index gear and main latching components in accordance with general features of the present invention.

FIG. 4 illustrates the latch mechanism wherein the index gear is in the “open” position, the claw is in the “Open” position, and the Sill Knob is in the “Unlocked” position, a configuration referred to as the “Open” state.

FIG. 5 illustrates the latch mechanism wherein the index gear in an “open/ready to close” position, while the claw is in the “soft closed” position. The sill knob is in the “unlocked” position.

FIG. 6 illustrates the latch mechanism wherein the index gear in “power close” position, the claw is in the “closed” position and the sill knob is in an “unlocked” position.

FIG. 7 illustrates the latch mechanism wherein the index gear in an “unlocked/closed/ready to open” position, the claw in the “closed” position, and the sill knob in the “unlocked” position.

FIG. 8 illustrates the latch mechanism wherein the index gear in a “locked” position, the claw in a “closed” position, and the sill knob in a “locked” position.

FIG. 9 illustrates the latch mechanism wherein the index gear in the “super locked” position, the claw in the “closed” position, and the sill knob is in the “locked” position.

### DETAILED DESCRIPTION OF THE INVENTION

The particular values and configurations discussed in these non-limiting examples can be varied and are cited merely to illustrate at least one embodiment of the present invention and are not intended to limit the scope of the invention.

The attached PowerPoint presentation if incorporated herein by reference for its illustration of drawings and discussion of embodiments of the present invention. The attached presentation is therefore an integral part of the specification for the present invention.

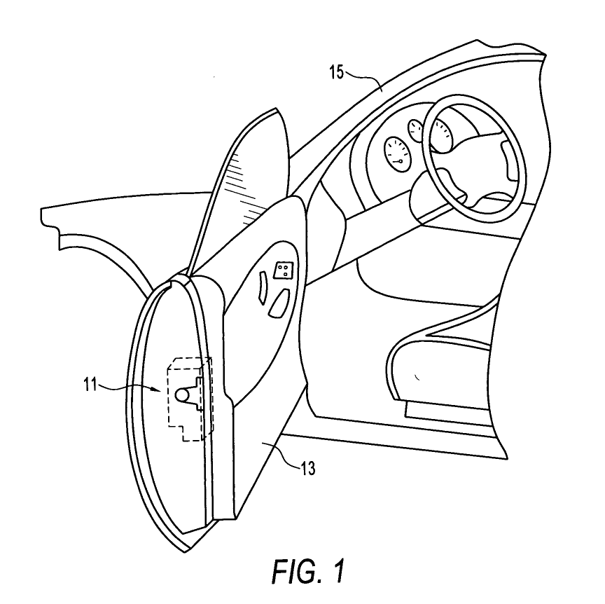

FIG. 1 illustrates a perspective view of a vehicle door 13 mounted to a passenger vehicle in which a preferred embodiment of the present invention can be implemented. Note that in FIGS. 1-9, identical or similar parts or elements are generally indicated by identical reference numerals. A vehicle, such as an automobile can be equipped with one or more individual door latch assemblies 11, which secure respective passenger and driver side doors to the vehicle 15. Each door latch assembly 11 is typically provided with manual release mechanisms for unlatching the door latch from the inside and outside of the vehicle, e.g. respective inner and outer door handles. In addition, many vehicles can also be equipped with electrically controlled actuators for remotely locking and unlocking the door latches. As indicated in FIG. 1, a door latch assembly 11 can be mounted to a driver's side vehicle door 13 of a passenger vehicle 15. The door latch assembly 11 may be mounted to front and rear passenger side doors thereof and may be incorporated into a sliding side door, rear door, a rear hatch or a lift gate thereof, depending upon design constraints.

A system and method for registering the drive mechanism position of a latching system after loss of power requiring the use of sensors and targets specifically located on existing latches for registration functions will now be described. As can be appreciated by those skilled in the art that a sensor can include magnetic, optical, mechanical and/or electrical functions. If the sensor is, for example, a Hall Effect sensor, the target would be magnetic. The present invention avoids electrical-mechanical malfunctions encountered with power loss using prior Latch designs using the unique registration system descried herein. The possible states that the present latch-registration system can keep track of include: Open (ready to close); Soft Closed (ready to power close); Power Closed; Closed & unlocked (ready to open); closed & Locked; Closed and super Locked.

The following table, Table 1, provides a listing of the powered up state, remembered state and control mechanism action.

TABLE 1

| Power Up State | Remembered State | Control Mechanism Action |
|---|---|---|
| Claw is Open, | Power Close | Drive from Ready to Close, through Ready |
| Latch is | | to Open. Continue to drive towards Locked |
| Mechanically | | until “Lock Sensor” changes state. Reverse |
| Unlocked | | direction & drive to Ready to Close. |
| | Open, Unlocked | Drive from Ready to Close, through Ready |
| | | to Open. Continue to drive towards Locked |
| | | until “Lock Sensor” changes state. Reverse |
| | | direction & drive to Ready to Close. |
| | Open, Mechanically | Drive from Ready to Close, through Ready |
| | Locked | to Open. Continue to drive towards Locked |
| | | until “Lock Sensor” changes state. Reverse |
| | | direction & drive to Ready to Close. |
| | Closed, Unlocked | Drive towards Locked until “Lock Sensor” |
| | | changes state. Reverse direction & drive to |
| | | Ready to Close. |
| | Closed & Locked | Drive to Unlocked. Reverse direction until |
| | | “Lock Sensor” changes state. Reverse |
| | | direction & drive to Ready to Close. |
| | Closed & Superlocked | Drive to Unlocked. Reverse direction until |
| | (only on Doors | “Lock Sensor” changes state. Reverse |
| | equipped with a Key | direction & drive to Ready to Close. |
| | mechanism) | |
| Claw is Open, | Power Close | Drive from Ready to Close, through Ready |
| Latch is | | to Open. Continue to drive towards Locked |
| Mechanically | | until “Lock Sensor” changes state. Reverse |
| Locked | | direction & drive to Ready to Close. Latch |
| | | will electronically drive to Lock after Claw is |
| | | Closed. |
| | Open, Unlocked | Drive from Ready to Close, through Ready |
| | | to Open. Continue to drive towards Locked |
| | | until “Lock Sensor” changes state. Reverse |
| | | direction & drive to Ready to Close. Latch |
| | | will electronically drive to Lock after Claw is |
| | | Closed. |
| | Open, Mechanically | Drive from Ready to Close, through Ready |
| | Locked | to Open. Continue to drive towards Locked |
| | | until “Lock Sensor” changes state. Reverse |
| | | direction & drive to Ready to Close. Latch |
| | | will electronically drive to Lock after Claw is |
| | | Closed. |
| | Closed, Unlocked | Drive towards Locked until “Lock Sensor” |
| | | changes state. Reverse direction & drive to |
| | | Ready to Close. Latch will electronically |
| | | drive to Lock after Claw is Closed. |
| | Closed & Locked | Drive to Unlocked. Reverse direction until |
| | | “Lock Sensor” changes state. Reverse |
| | | direction & drive to Ready to Close. Latch |
| | | will electronically drive to Lock after Claw is |
| | | Closed. |
| | Closed & Superlocked | Drive to Unlocked. Reverse direction until |
| | (only on Doors | “Lock Sensor” changes state. Reverse |
| | equipped with a Key | direction & drive to Ready to Close. Latch |
| | mechanism) | will electronically drive to Lock after Claw is |
| | | Closed. |
| Claw is Closed, | Power Close | Drive from Ready to Close, through Ready |
| Latch is Unlocked | | to Open. Continue to drive towards Locked |
| | | until “Lock Sensor” changes state. Reverse |
| | | direction & drive to Ready to Open. |
| | Open, Unlocked | Drive from Ready to Close, through Ready |
| | | to Open. Continue to drive towards Locked |
| | | until “Lock Sensor” changes state. Reverse |
| | | direction & drive to Ready to Open. |
| | Open, Mechanically | Drive from Ready to Close, through Ready |
| | Locked | to Open. Continue to drive towards Locked |
| | | until “Lock Sensor” changes state. Reverse |
| | | direction & drive to Ready to Open. |
| | Closed, Unlocked | Drive towards Locked until “Lock Sensor” |
| | | changes state. Reverse direction & drive to |
| | | Ready to Open. |
| | Closed & Locked | Drive to Unlocked. Reverse direction until |
| | | “Lock Sensor” changes state. Reverse |
| | | direction & drive to Ready to Open. |
| | Closed & Superlocked | Drive to Unlocked. Reverse direction until |
| | (only on | “Lock Sensor” changes state. Reverse |
| | Doors equipped | direction & drive to Ready to Open. |
| | with a Key | |
| | mechanism) | |
| Claw is Closed, | Power Close | Drive from Ready to Close, through Ready |
| Latch is Locked | | to Open. Continue to drive towards Locked |
| | | until “Lock Sensor” changes state. Continue |
| | | to drive to Locked. |
| | Open, Unlocked | Drive from Ready to Close, through Ready |
| | | to Open. Continue to drive towards Locked |
| | | until “Lock Sensor” changes state. Continue |
| | | to drive to Locked. |
| | Open, Mechanically | Drive from Ready to Close, through Ready |
| | Locked | to Open. Continue to drive towards Locked |
| | | until “Lock Sensor” changes state. Continue |
| | | to drive to Locked. |
| | Closed, Unlocked | Drive towards Locked until “Lock Sensor” |
| | | changes state. Continue to drive to Locked. |
| | Closed & Locked | Drive to Unlocked. Reverse direction until |
| | | “Lock Sensor” changes state. Continue to |
| | | drive to Locked. |
| | Closed & Superlocked | Drive to Unlocked. Reverse direction until |
| | (only on Doors | “Lock Sensor” changes state. Continue to |
| | equipped with a Key | drive to Locked. |
| | mechanism) | |
| Claw is Closed, | Power Close | Drive from Ready to Close, through Ready |
| Latch is | | to Open. Continue to drive towards Locked |
| Superlocked | | until “Lock Sensor” changes state. Continue |
| (only on Doors | | to drive to Superlocked. |
| equipped with | Open, Unlocked | Drive from Ready to Close, through Ready |
| a Key mechanism) | | to Open. Continue to drive towards Locked |
| | | until “Lock Sensor” changes state. Continue |
| | | to drive to Superlocked. |
| | Open, Mechanically | Drive from Ready to Close, through Ready |
| | Locked | to Open. Continue to drive towards Locked |
| | | until “Lock Sensor” changes state. Continue |
| | | to drive to Superlocked. |
| | Closed, Unlocked | Drive towards Locked until “Lock Sensor” |
| | | changes state. Continue to drive to |
| | | Superlocked. |
| | Closed & Locked | Drive to Unlocked. Reverse direction until |
| | | “Lock Sensor” changes state. Continue to |
| | | drive to Superlocked. |
| | Closed & Superlocked | Drive to Unlocked. Reverse direction until |
| | (only on Doors | “Lock Sensor” changes state. Continue to |
| | equipped with a Key | drive to Superlocked. |
| | mechanism) | |

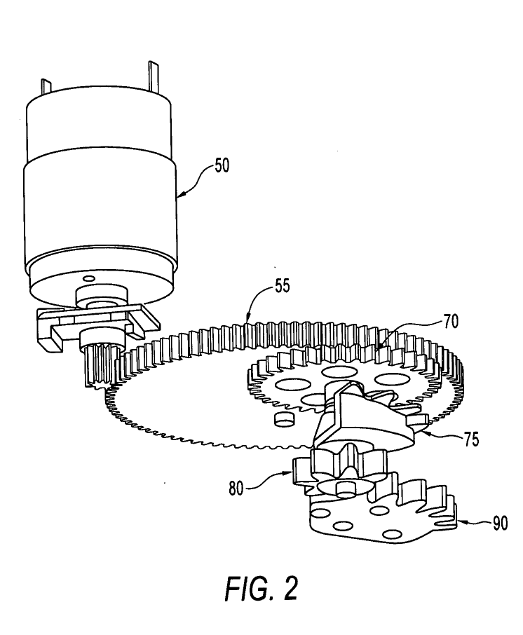

Referring to FIG. 2, components associated with the latch that are operable for position registration in accordance with the present invention are illustrated. A motor 50 turns a main drive/motor interface 55, which can include an integrated main drive pinion to drive a registration gear 70 that is in turn coupled to an index gear 75. The index gear 75 is what typically requires reorientation after power loss once it has been determine using magnets and sensors deployed throughout the latch system that components have been moved from their respective pre-power loss positions. Also coupled beneath the index gear 75 are a first power close drive gear 80 and a second power close drive gear 90 coupled beneath the first power close drive gear 80.

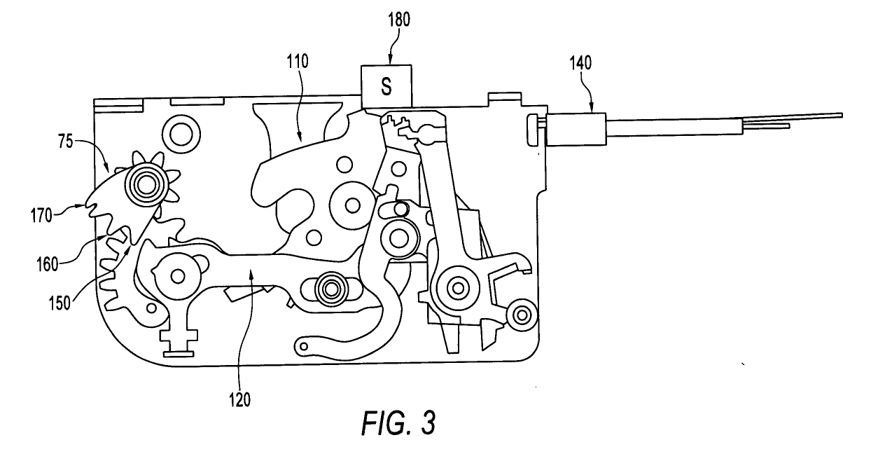

Referring to FIG. 3, the index gear 75 and main latching components are shown in accordance with general features the present invention. In general, a motor and/or gear train (not shown) drives the index gear 75. The index gear 75 is what typically requires reorientation after power loss once it has been determined using targets and sensors deployed throughout the latch system that components have been moved from their respective pre-power loss positions. Also coupled beneath the index gear 75 are a first and second power close drive gear (not shown). The index gear 75 is shown, such that the position of claw 110 is driven by the power close drive gear 90 depicted in FIG. 2, and the linkage 120 and/or the cabling 140. The index gear shown contains four (4) teeth (Index Gears shown in other views may only have three (3) teeth). Each tooth causes manipulation of linkages 120.

In the latch illustrated in FIG. 3, the first tooth 150 is used for Superlock/Un-superlock operation. A second tooth 160 manipulates the linkages for Lock/Unlock operations. The third tooth is extra, for an undefined function. The fourth tooth 170 is utilized for Power open operations. Also shown is a sensor block 180. Sensors in the sensor block 180 are used to sense the location of the claw 110 and other hardware associated with the latch. The claw 110, for example, would have targets integrated along its edge that move in close proximity with the sensor block 180. The targets (not shown) enable the sensors to detect the position of claw 110.

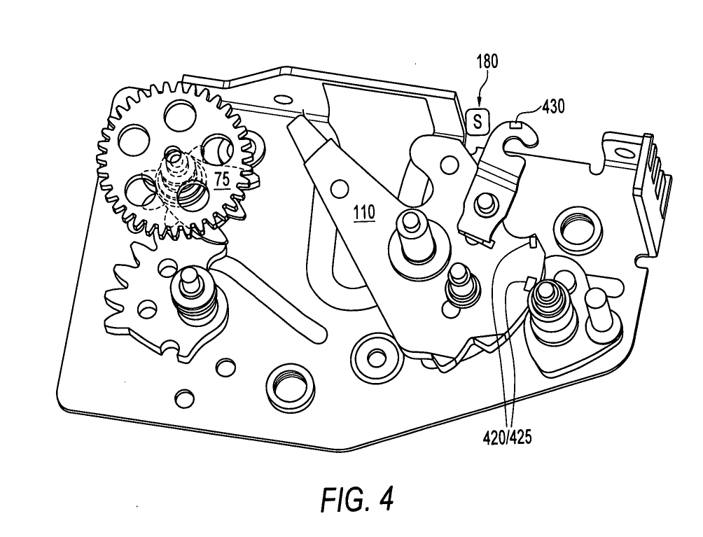

Referring to FIG. 4, the index gear 75 marks a power loss location, or the remembered state for the claw 110 and a sill knob, which are main components of the latch. As shown in FIG. 4, the index gear 75 is in the “open/ready to close” position. The claw 110 is in the “Open” position, while the Sill Knob is in the “unlocked” position. This is referred to as the “open/ready to close” state. Also shown in FIG. 4 are the location of targets on the claw 110 and the sill knob. First and second claw targets 420/425 are location along the edge of the claw 110 as shown. A sill knob target 430 is shown integrated on the top edge of the sill knob.

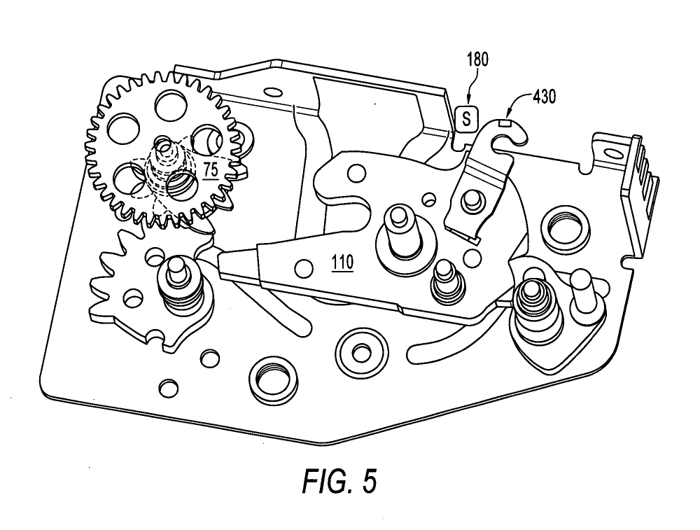

Referring to FIG. 5, the index gear 75 is shown in the “open/ready to close” position, while the claw is in the “soft closed” position. The sill knob is in the “unlocked” position. This is referred to as the “soft closed” state.

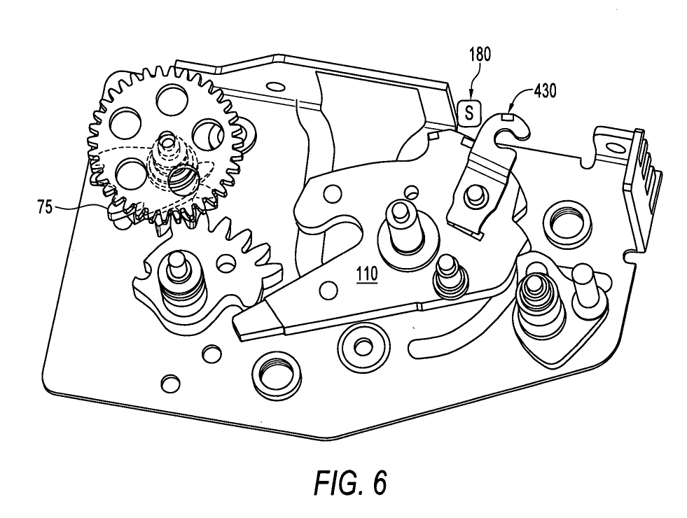

Referring to FIG. 6, the index gear 75 is shown in “power close” position, the claw 110 is in the “closed” position and the sill knob is in the “unlocked” position. This is referred to as the “power close” state.

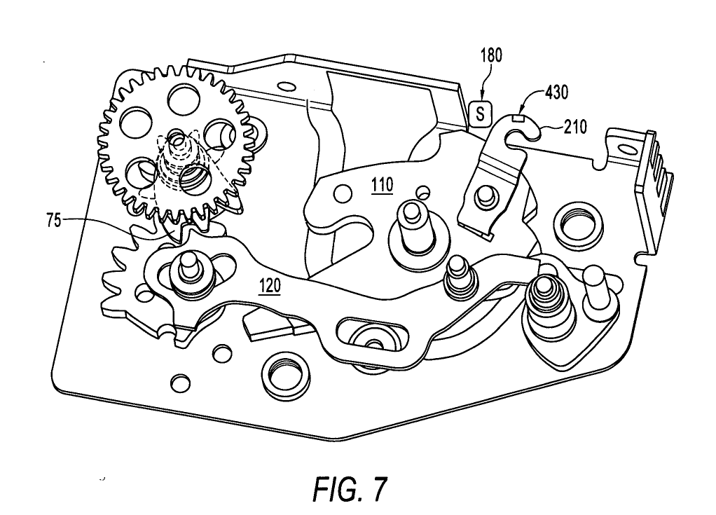

Referring to FIG. 7, the index gear 75 is shown in “unlocked/closed/ready to open” position, the claw 110 is in the “closed” position, and the sill knob is in the “unlocked” position. This is referred to as the “closed & unlocked/ready to open” state.

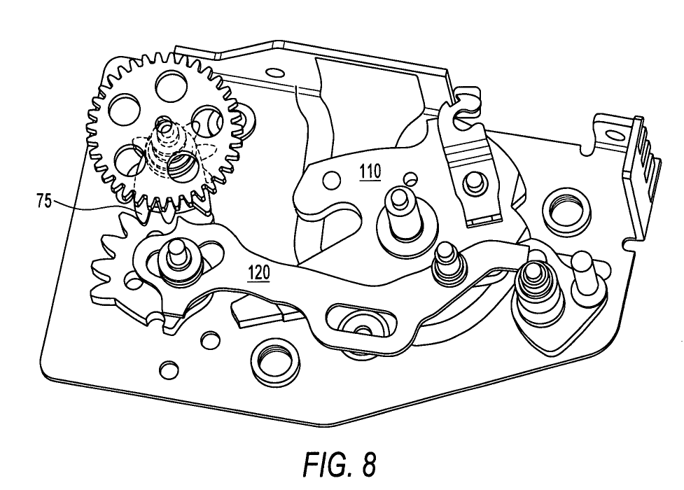

Referring to FIG. 8, the index gear 75 is shown in “locked” position, the claw 110 is in the “closed” position, and the sill knob is in the “locked” position. This is referred to as the “closed & locked” state.

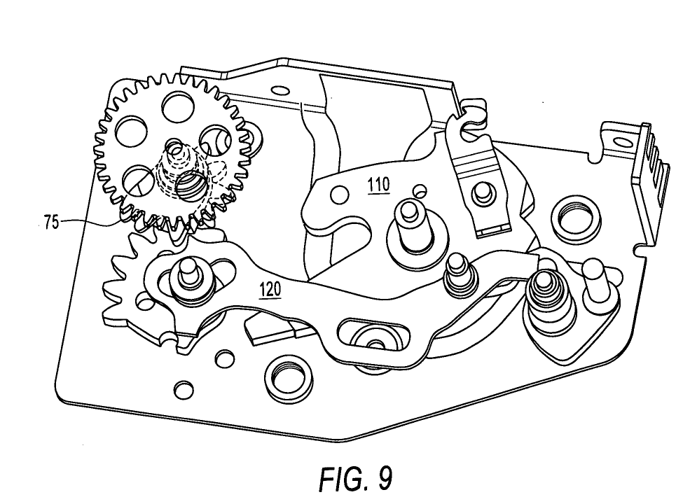

Referring to FIG. 9, the index gear 75 is shown in “super locked” position, the claw 110 is in the “closed” position, and the sill knob is in the “locked” position. This is referred to as the “super locked” state.

The proposed method is based on the following assumptions. The latch will remember the state that it was in when power was lost. Upon Power Up, the Latch will, be able to sense whether the Claw is Open/Soft Closed/Closed and whether the latch is Locked/Unlocked. The point at which the Lock Sensor changes state from the unlocked condition is repeatable enough to be used as a registration point. The Latch will mechanically return to Ready to Close from anywhere in the Power Close function if power is lost while performing a Power Close. The Latch cannot be Locked/Superlocked (mechanically/electronically) when the Claw is in the “Open” position if it is installed in a door with a Key. The Latch does not Electronically Lock if the Latch is Mechanically Locked While the Claw is “Open”. If installed on a door w/out a Key, the Latch can only move into/out of Superlock via the electronic drive.

The possible states that the a latch can be electronically driven to are: Power Close, Open/Ready to Close (Claw is open), Closed/Ready to Open (Claw is closed to the 2nd Position), Locked (Claw is Closed to the 2nd Position, and the Sill Knob Lever is in the Engaged position, Superlocked (Claw is Closed to the 2nd Position, the Sill Knob Lever is in the Engaged position, and the Superlock function is engaged). When powered up, the action of the Latch will depend on the “Remembered State” and the “Current State.” If the “remembered state” and the “Current state” are in conflict, then the motor can drive the index gear, via the registration gear, to a matching “current state.” Alternatively, it can be appreciated that the latch hardware (e.g., claw, sill knob, etc.) can be mechanically driven to match the remembered state as indicated by the position of the index gear.

In accordance with a preferred embodiment of the invention, an improved latch is provided that uses one small motor to effect a number of independent electrical actuations including at least two of: Central Locking, Super Locking, Selective Locking, Power/electrical door opening (Passive opening), Power/electrical door closing (Soft closing). The latch can be adapted easily to secure any type of closure including side doors, trunk, rear doors, swing or sliding doors. The drive mechanism stops mechanically as well as electrically at either end of its actuation course; however, if the electronic management unit or any of the sensors fail to function, the motor will automatically stop at one of two neutral, mechanical, dead-end stop positions. If the power supply fails while the drive mechanism is in an intermediate position, the drive mechanism returns automatically, mechanically to a neutral position.

The embodiments and examples set forth herein are presented to best explain the present invention and its practical application and to thereby enable those skilled in the art to make and utilize the invention. Those skilled in the art, however, will recognize that the foregoing description and examples have been presented for the purpose of illustration and example only. Other variations and modifications of the present invention will be apparent to those of skill in the art, and it is the intent of the appended claims that such variations and modifications be covered.

The description as set forth is not intended to be exhaustive or to limit the scope of the invention. Many modifications and variations are possible in light of the above teaching without departing from the scope of the following claims. It is contemplated that the use of the present invention can involve components having different characteristics. It is intended that the scope of the present invention be defined by the claims appended hereto, giving full cognizance to equivalents in all respects.

What is claimed is:

1. A system for registering drive mechanism position of a latching system after loss of power, comprising
a latch including a claw and sill knob, said claw and sill knob including targets integrated thereon;
at least one sensor, said sensor for detecting the presence of a target associated with either of said claw and/or sill knob;
a registration gear driven by an electric motor;
an index gear manipulated in position by the registration gear; and
an electronic control system for matching position of the index gear with at least one of the claw or the sill knob based on the location of said target with respect to said at least one sensor.

2. The system for claim 1 wherein the latch can be electronically driven to states including at least one of: power close, open and ready to close, closed and ready to open, locked, and superlocked.

3. The system of claim 1, wherein action of the latch will depend on at least one of a remembered state and/or a current state after the latch is powered up.

4. The system of claim 3, wherein then the electric motor drives the index gear, via the registration gear, to a matching current state if the remembered state and the current state are in conflict after a loss of electrical power.

5. The system of claim 1, wherein at least one of the claw and/or sill knob is mechanically driven to match the remembered state as indicated by the position of the index gear.

6. A method for registering drive mechanism position of an electric latch after loss of electrical power, the method comprising the steps of:
applying electrical power to an electric latch, said electric latch including a claw and a sill knob, said claw and sill knob including targets integrated thereon and at least one sensor for detecting the presence of a target associated with at least one of the claw and/or the sill knob, a registration gear driven by an electric motor, an index gear manipulated in position by the registration gear, and an electronic control system for matching position of the index gear with at least one of the claw or the sill knob based on the location of said target with respect to said at least one sensor;
determining the drive mechanism position of the electric latch using the electronic control system; and
electronically driving the electric latch to states including at least one of: power close, open and ready to close, closed and ready to open, locked, and superlocked.

7. The method of claim 6, wherein mechanical action over the latch will depend on at least one of a remembered state and/or a current state determined by the drive mechanism position of the electric latch after the electric latch is powered up.

8. The method of claim 7, wherein the electric motor drives the registration gear which moves the index gear into a matching current state if the remembered state and the current state are in conflict.

9. The method of claim 6, wherein at least one of the claw and/or sill knob is mechanically driven to match a remembered state as indicated by the position of the index gear.

10. A method for registering drive mechanism position of an electric latch after loss of electrical power, the method comprising the steps of:
applying electrical power to an electric latch, said electric latch including a claw and a sill knob, said claw and sill knob including targets integrated thereon and at least one sensor for detecting the presence of a target associated with at least one of the claw and/or the sill knob, a registration gear driven by an electric motor, an index gear manipulated in position by the registration gear, and an electronic control system for matching position of the index gear with at least one of the claw or the sill knob based on the location of said target with respect to said at least one sensor;
determining the drive mechanism position of the electric latch using the electronic control system; and
electromechanically driving at least one of the claw and/or sill knob to match a remembered state as indicated by the position of the index gear.

11. The method of claim 10 including the step of electromechanically driving the electric latch to states including at least one of: open, power close, open and ready to close, closed and ready to open, locked, and superlocked.

12. The method of claim 10, wherein mechanical action over the latch will depend on at least one of a remembered state and/or a current state determined by the drive mechanism position of the electric latch after the electric latch is powered up.

13. The method of claim 10, wherein the electric motor drives the registration gear which moves the index gear into a matching current state if the remembered state and the current state are in conflict.
